(19) United States
(12) Patent Application Publication
(10) Pub. No.: US 2022/0026983 A1
(43) Pub. Date: Jan. 27, 2022

(54) METHOD FOR SUPPLEMENTING PERFORMANCE OF SENSOR DISPOSED UNDER DISPLAY AND ELECTRONIC DEVICE FOR PERFORMING SAME

(71) Applicant: Samsung Electronics Co., Ltd., Suwon-si (KR)

(72) Inventors: Jaemyung LEE, Suwon-si (KR); Sungyoung SHIN, Suwon-si (KR); Hyunho SHIN, Suwon-si (KR); Yongkoo HER, Suwon-si (KR); Joohyun KIM, Suwon-si (KR)

(21) Appl. No.: 17/450,059

(22) Filed: Oct. 5, 2021

Related U.S. Application Data
(63) Continuation of application No. PCT/KR2020/004308, filed on Mar. 30, 2020.

(30) Foreign Application Priority Data
Apr. 5, 2019 (KR) 10-2019-0040391

(51) Int. Cl. G06F 3/01; G09G 5/10; H04N 5/225; H04N 5/232; H04M 1/02

(52) U.S. Cl. CPC G06F 3/011; G09G 5/10; H04N 5/2257; H04N 5/232121; H04M 1/0264; H04N 5/232411; G09G 2354/00; G09G 2360/144; G09G 2330/027; H04M 2250/12; H04M 2250/52; H04N 5/23245

(57) ABSTRACT

An electronic device according to various embodiments of the present invention may comprise: a display; a camera module; a sensor module disposed under the display and configured to perform a sensing function; a processor operably connected to the display, the camera module, and the sensor module; and a memory operably connected to the processor. The memory, when executed, may cause the processor to measure first data using the sensor module, identify the amount of the first data that deviates from an operating range; and perform at least one function of the camera module by in response to the amount of the first data deviating from the operating range. In addition, other embodiments are possible.

### CROSS-REFERENCE TO RELATED APPLICATIONS

This application is a continuation of International Application No. PCT/KR2020/004308, filed Mar. 30, 2020, which claims priority to Korean Patent Application No. 10-2019-0040391, filed Apr. 5, 2019, the disclosures of which are herein incorporated by reference in their entirety.

### BACKGROUND

### 1. Field

Various embodiments of the disclosure relate to a method for supplementing performance of a sensor disposed under a display and an electronic device performing the same.

### 2. Description of Related Art

A portable electronic device, such as a smartphone, may be limited in size for easy carrying thereof. With the development of technology, the occupancy rate of a screen in the portable electronic device may be gradually increased, and relatively, the bezel corresponding to the border of the screen may be gradually decreased. For example, most of one surface of the portable electronic device may be used as the display screen, and an area in which at least one sensor is disposed may visually disappear. As the occupancy rate of the screen is maximized within a limited size, various sensors may be disposed under the screen (e.g., display panel), and the sensors may not be visually seen.

### SUMMARY

An electronic device may display a screen corresponding to the whole of one surface of the electronic device, and at least one sensor may be disposed under a display panel corresponding to the screen. For example, an illuminance sensor for measuring brightness of the surroundings and a proximity sensor for detecting proximity of an object may be disposed under the display panel. At least one sensor disposed under the display panel may measure the brightness of the surroundings or detect the proximity or not of the object. According to an embodiment, in embodiments where the electronic device displays a specific image through the display panel, the change of illumination values according to the playback of the specific image may occur frequently. When the image is played in the electronic device, the detection performance of the at least one sensor disposed under the display panel may be degraded. The detection performance of the at least one sensor may be degraded at least partly depending on an external environment and the operation mode of the electronic device.

According to various embodiments, in the electronic device (e.g., full-screen electronic device) having the whole of one surface being displayed as the screen, at least one sensor may be disposed under the display panel. Since the detection performance of the at least one sensor disposed under the display panel may be degraded, the electronic device may supplement the detection performance of the at least one sensor through utilizing information obtained from another kind of device (e.g., camera module).

An electronic device according to various embodiments of the disclosure may include a display, a camera module, a sensor module disposed under the display, a processor operatively connected to the display and configured to perform a sensing function, the camera module, and the sensor module, and a memory operatively connected to the processor. The memory, when executed, may store instructions for causing the processor to: measure first data using sensor module, identify an amount of the first data that deviates from an operating range, and perform at least one function of the camera module in response to the amount of the first data deviating from the operating range.

A method according to various embodiments of the disclosure may include performing a sensing function using a sensor module disposed under a display of an electronic device, measuring first data using the sensor module, identifying an amount of the first data that deviates from an operating range, and performing at least one function of the camera module in response to the amount of the first data deviating from the operating range.

The electronic device (e.g., full screen electronic device) according to various embodiments of the disclosure can supplement the sensing performance of at least one sensor by utilizing both the at least one sensor and another kind of device (e.g., camera module) disposed under the display panel. The electronic device can display a full screen corresponding to one surface thereof, and thus can maximize the display area of the screen. In addition, various effects being directly or indirectly grasped through this document can be provided.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of an electronic device in a network environment according to various embodiments.

FIG. 2 is a diagram illustrating a layout structure of sensors disposed under a display panel according to various embodiments.

FIG. 3 is a block diagram of an electronic device according to various embodiments.

FIG. 4 is a flowchart illustrating a method for supplementing a sensing function of a sensor module utilizing a camera according to various embodiments.

FIG. 5A is a flowchart illustrating a method for supplementing a sensing function of an illuminance sensor utilizing a camera according to various embodiments.

FIG. 5B is a flowchart illustrating a method for supplementing a sensing function of a proximity sensor utilizing a camera according to various embodiments.

FIG. 6 is a flowchart illustrating a method for performing a sensing function depending on whether to execute a camera mode according to various embodiments.

### DETAILED DESCRIPTION

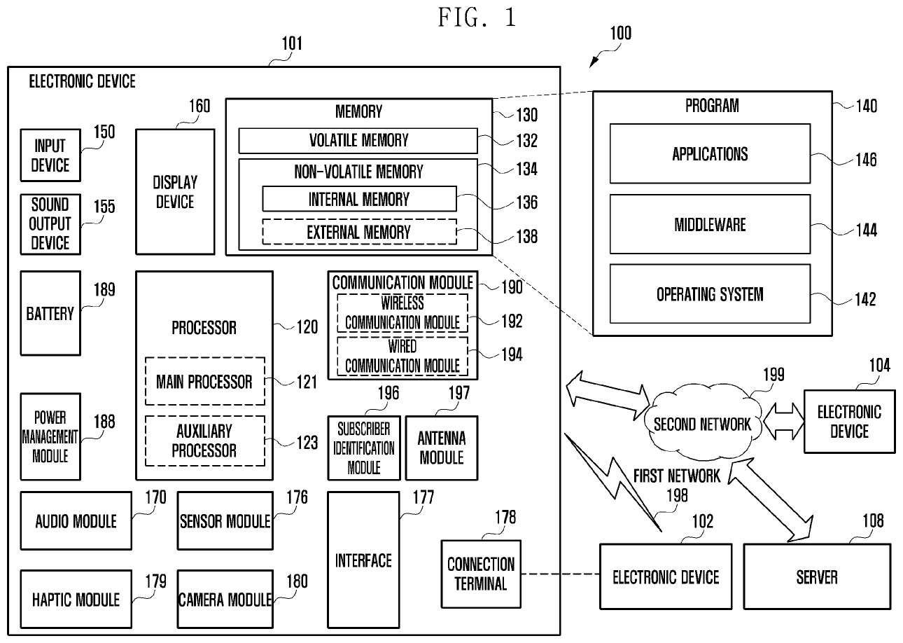

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 (e.g., DRAM, SRAM, or SDRAM) or the non-volatile memory 134.

The program 140 may be stored in the memory 130 as software, and may include, for example, an operating system (OS) 142, middleware 144, or an application 146 (e.g., application program).

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch. According to an embodiment, a display 160 may include a display panel, and may display at least one content (e.g., image, video, and/or user interface) based on the display panel. According to an embodiment, the display 160 may be configured as a full screen corresponding to one surface of an electronic device 101. According to an embodiment, the display 160 may turn off the screen corresponding to at least a part of a display. For example, the display 160 may deactivate a screen display function for at least a partial area (e.g., sensing area in which at least one sensor module 176 is disposed).

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. According to various embodiments, at least a part of the sensor module 176 may be disposed under the display panel corresponding to the display 160. According to an embodiment, while outputting a screen through the display panel, the electronic device 101 may detect a distance from an object approaching the display panel using a proximity sensor, and may detect brightness of the surroundings using an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes. According to an embodiment, a camera module 180 may detect an external object, and may measure a separated distance from the object. The camera module 180 may adjust a focus on the external object using an image sensor. The camera module 180 may measure the brightness of the surroundings, and may adjust the contrast and saturation of an image in accordance with the measured brightness of the surroundings.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit a signal or a power to an outside (e.g., external electronic device), or may receive the signal or the power from the outside. The antenna module 197 may include one antenna including a conductor formed on a substrate (e.g., PCB) or a radiator composed of a conductive pattern. According to an embodiment, the antenna module 197 may include a plurality of antennas. In this case, at least one of the plurality of antennas, which is suitable to a communication method being used in a communication network, such as a first network 198 or a second network 199, may be selected by, for example, a communication module 190. The signal or the power may be transmitted or received between the communication module 190 and the external electronic device through the selected at least one antenna. According to a certain embodiment, in addition to the radiator, another component (e.g., RFIC) may be additionally formed as a part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

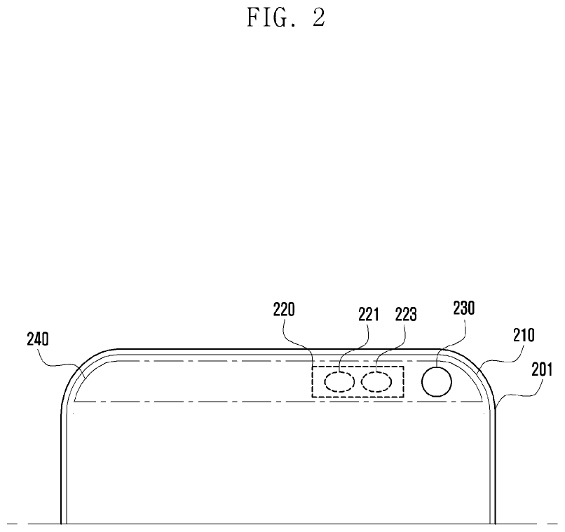

FIG. 2 is a diagram illustrating a layout structure of sensors disposed under a display panel according to various embodiments.

Referring to FIG. 2, an electronic device 201 (e.g., electronic device 101 of FIG. 1) may use most of one surface (e.g., front surface or head) thereof as a screen. For example, a display panel 210 (e.g., display 160 of FIG. 1) may be disposed corresponding to the front surface of the electronic device 201, and the screen may be displayed through the display panel 210. According to an embodiment, the display panel 210 may occupy most of the front surface of the electronic device 201, and a bezel area corresponding to the border of the display panel 210 may be minimized. According to an embodiment, a sensor module 220 (e.g., sensor module 176 of FIG. 1) of the electronic device 201 may be disposed under the display panel 210, and at least a part of the sensor module 220 may not be visually seen through the display panel 210. According to an embodiment, the sensor module 220 may include at least one sensor (e.g., illuminance sensor 221 and/or proximity sensor 223). According to an embodiment, the sensor module 220 may be disposed based on a sensing area 240, and the sensing area 240 is not limited to a specific form. According to an embodiment, the electronic device 201 may display the screen corresponding to a remaining area excluding the sensing area 240.

According to an embodiment, a camera (e.g., camera module 180 of FIG. 1) of the electronic device 201 may be partly disposed under the display panel 210. At least a part of constituent elements (e.g., wiring) may be removed or differently disposed on one area 230 of the display panel 210 corresponding to the location of the camera so as to receive an external light. According to an embodiment, the camera of the electronic device 201 may receive an external light through the one area 230 of the display panel 210, and may photograph an image. For example, a lens of the camera may be visually seen through the one area 230 of the display panel 210.

According to an embodiment, under the display panel 210, the illuminance sensor 221 and the proximity sensor 223 may be disposed at least partly. Referring to FIG. 2, the illuminance sensor 221 and the proximity sensor 223 may be included in the sensor module 220, and although it is illustrated that the sensor module 220 is disposed on a top part of the screen of the electronic device 201, the disposition of the sensor module 220 is not limited thereto. According to an embodiment, the sensor module 220 of the electronic device 201 may be partly disposed under the display panel 210. According to an embodiment, an area in which the sensor module 220 is disposed to perform a sensing function may be the sensing area 240. According to an embodiment, since the sensor module 220 is disposed under the display panel 210, the performance of the sensing function may be degraded. The sensor module 220 may be at least partly hidden by the display panel 210, and thus the performance of the sensing function may be degraded.

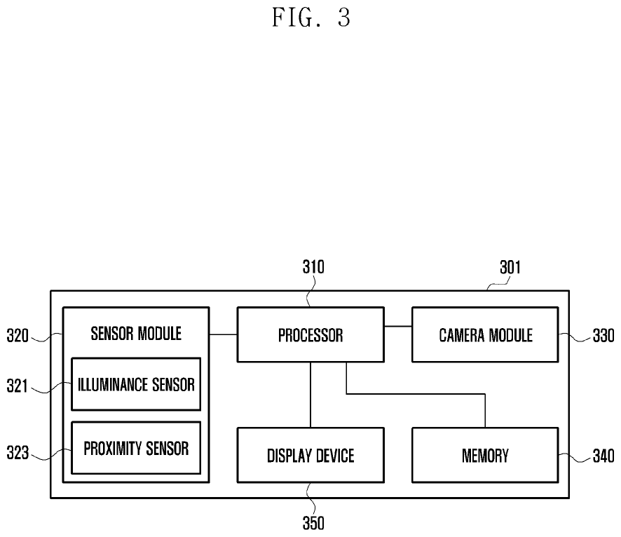

FIG. 3 is a block diagram of an electronic device according to various embodiments.

Referring to FIG. 3, an electronic device 301 (e.g., electronic device 101 of FIG. 1) may include a processor 310 (e.g., processor 120 of FIG. 1), a sensor module 320 (e.g., sensor module 176 of FIG. 1), a camera module 330 (e.g., camera module 180 of FIG. 1), a memory 340 (e.g., memory 130 of FIG. 1), and a display 350 (e.g., display 160 of FIG. 1).

The processor 310 may control at least one constituent part (e.g., sensor module 320, camera module 330, memory 340, and display 350) so as to perform an overall operation of the electronic device 301. For example, the processor 310 may perform a command stored in the memory 340, and may control at least one piece of hardware to perform an operation corresponding to the command.

According to an embodiment, the processor 310 may perform a sensing function using at least one sensor (e.g., illuminance sensor 321 and/or proximity sensor 323) included in the sensor module 320. For example, the processor 310 may measure the brightness or illumination of the surroundings using the illuminance sensor 321, and may adjust the brightness (e.g., contrast and saturation) of the screen based on the measured brightness or illumination. According to an embodiment, the processor 310 may automatically adjust a backlight of the display panel included in the display 350 based on the measured brightness. The processor 310 may detect whether an object approaches the electronic device 301 using the proximity sensor 323, and may deactivate the display 350 at least partly when the object approaches within a configured distance. For example, when a user makes a call, the proximity sensor 323 may detect that the user's face has approached, and in response to the detection, the processor 310 may deactivate the display 350 at least partly. For example, the processor 310 may determine whether to turn off the screen of the electronic device 301 or whether to perform an always on display (AOD) function.

According to an embodiment, the processor 310 may measure a distance from an object corresponding to a photographing target using at least one function of the camera module 330, and may focus on the object based on the measured distance. According to an embodiment, the processor 310 may measure the brightness of the surroundings or obtain information about the photographing using an image sensor included in the camera module 330. The processor 310 may configure a photographing condition of the object based on the measured brightness of the surroundings and the information about the photographing, and may photograph the object based on the configured photographing condition.

According to an embodiment, the processor 310 may identify instructions stored in the memory 340, and may control at least one constituent part (e.g., sensor module 320, camera module 330, and/or display 350) based on the instructions. For example, the memory 340 may store data about a sensing value (e.g., illumination value and distance from an object) by the sensor module 320 and the brightness of the surroundings.

According to an embodiment, the processor 310 may display the screen based on the display panel corresponding to the display 350. For example, the processor 310 may identify the brightness of the surroundings using the sensor module 320, and may adjust the brightness of the display 350 based on the identified brightness.

The electronic device 301 according to various embodiments of the disclosure may include the display (e.g., display 350), the camera module 330, the sensor module 320 disposed under the display, the processor 310 operatively connected to the display, the camera module 330, and the sensor module 320, and the memory 340 operatively connected to the processor 310. According to various embodiments, the processor 310 may perform the sensing function using the sensor module 320, measure first data by the sensing function of the sensor module 320, measure an amount of change of the first data, and perform at least one function of the camera module using the camera module in case that the measured amount of change of the first data deviates from a configured range.

According to various embodiments, the processor 310 may measure second data by the at least one function of the camera module 330, and may at least partly control the display based on at least one of the first data and the second data.

According to various embodiments, the sensor module 320 may include at least one of the illuminance sensor 321 and the proximity sensor 323, and the at least one of the illuminance sensor 321 and the proximity sensor 323 may be disposed under the display panel corresponding to the display.

According to various embodiments, the processor 310 may measure the first data using the illuminance sensor 321, identify that the illumination value of the illuminance sensor is under a threshold, and perform the at least one function of the camera module 330 in response to identifying that the illumination value is under the threshold.

According to various embodiments, the processor 310 may measure second data corresponding to a luminance value of surroundings using the camera module 330.

According to various embodiments, the processor 310 may identify integrated data based on the first data and the second data, and adjust a brightness of the display based on the identified integrated data.

According to various embodiments, the processor 310 may identify whether a change of data measured using the proximity sensor 323 continues, and perform at least one function of the camera module 330 depending on the result of the identifying.

According to various embodiments, the processor 310 may measure the first data corresponding to a distance from a user based on a transmitted light emitting signal and a received light receiving signal using the proximity sensor 323, and measure the second data corresponding to the distance from the user based on a depth obtaining method using the camera module 330.

According to various embodiments, the depth obtaining method may include at least one method of a focus adjustment method, a stereo vision method, a time of flight (TOF) method, a structured light method, and/or a gyro function based on a gyro sensor.

According to various embodiments, the processor 310 may measure the second data using the camera module 330 based on the at least one method.

According to various embodiments, the processor 310 may identify integrated data based on the first data and the second data, and control the display based on the identified integrated data.

According to various embodiments, the processor 310 may identify whether the electronic device is in an always on display (AOD) mode, in response to identifying that the electronic device is in the AOD mode, maintain a state of the display, and, in response to identifying that the electronic device is not in the AOD mode, at least partly turn off the display.

According to various embodiments, the processor 310 may identify whether a camera mode is executed through the camera module 330, in response to identifying that the camera mode is executed, turn off at least a partial area of the display , measure the first data by the sensing function of the sensor module 320, and control the display based on the measured first data.

According to various embodiments where the camera mode is not executed, the processor 310 may measure the first data by the sensing function of the sensor module 320 in case that the camera mode is not executed, measure second data by the at least one function of the camera module 330, and control the display based on at least one of the measured first data and the measured second data.

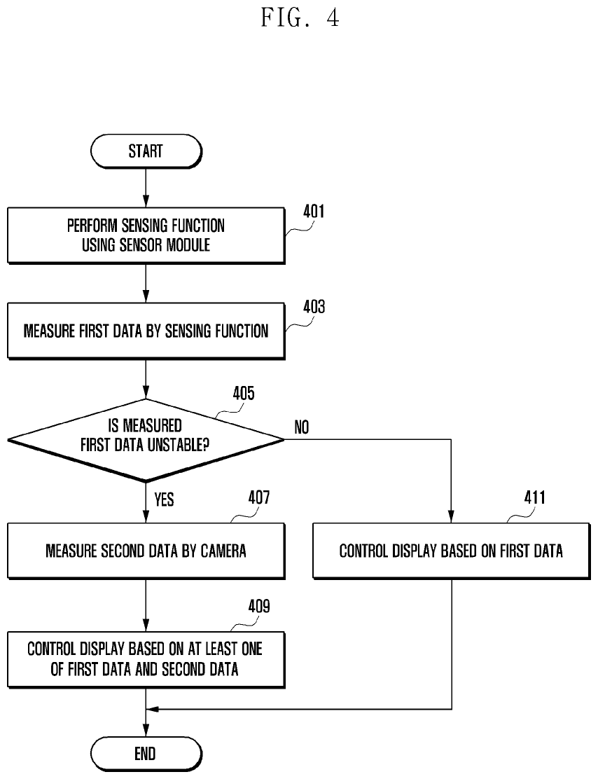

FIG. 4 is a flowchart illustrating a method for supplementing a sensing function of a sensor module utilizing a camera according to various embodiments.

Referring to FIG. 4, at operation 401, the processor (e.g., processor 310 of FIG. 3) of the electronic device (e.g., electronic device 301 of FIG. 3) may perform the sensing function using the sensor module (e.g., sensor module 320 of FIG. 3). For example, the sensor module 320 may include the illuminance sensor (e.g., illuminance sensor 321 of FIG. 3) and the proximity sensor (e.g., proximity sensor 323 of FIG. 3). The sensor module may be disposed under a display of an electronic device.

At operation 403, the processor 310 may measure the first data by the sensing function using the sensor module. For example, the processor 310 may measure the brightness of the surroundings using the illuminance sensor 321, and measure the distance from the user to the electronic device 301 using the proximity sensor 323. The processor 310 may determine whether the user has approached the electronic device 301 based on the measured distance.

At operation 405, the processor 310 may determine whether the measured first data is unstable. For example, the processor 310 may repeatedly measure the first data in accordance with configured time intervals, and may determine that the first data is unstable in case that the measured first data deviates from an operating range, and is changed from time to time. For example, if the measured first data is included in the operating range, the processor 310 may determine that the first data is stable. According to an embodiment, the processor 310 may measure the amount of change of the first data for a predetermined time, and if the amount of change of the first data deviates from the operating range, the processor 310 may determine that the first data is unstable data, whereas if the amount of change of the first data is included within the configured range, the processor 310 may determine that the first data is stable data.

If the first data is unstable at operation 405, the processor 310, at operation 407, may measure the second data by the camera (e.g., camera module 330 of FIG. 3). For example, the processor 310 may measure the second data using at least a partial function of the camera. For example, if the first data is data measured to correspond to the brightness of the surroundings, the processor 310 may measure the second data using the function of measuring the surrounding brightness of the camera. For example, if the first data is data obtained by measuring the distance from the user, the processor 310 may measure the second data using the function of measuring the distance between the camera and the object.

At operation 409, the processor 310 may control the display (e.g., display 350 of FIG. 3) based on the at least one of the first data and the second data. According to an embodiment, the processor 310 may adjust the brightness of the display. For example, the processor 310 may deactivate the screen display function through the display at least partly.

At operation 405, if the first data is stable, the processor 310, at operation 411, may control the display 350 based on the measured first data. For example, if the amount of change of the first data is included in the configured range, the processor 310 may determine the brightness of the display 350 based on the first data.

According to various embodiments, if the first data measured using the sensor module 320 is unstable, the processor 310 of the electronic device 301 may measure the second data using the camera. The processor 310 may control the display based on at least one of the first data and the second data.

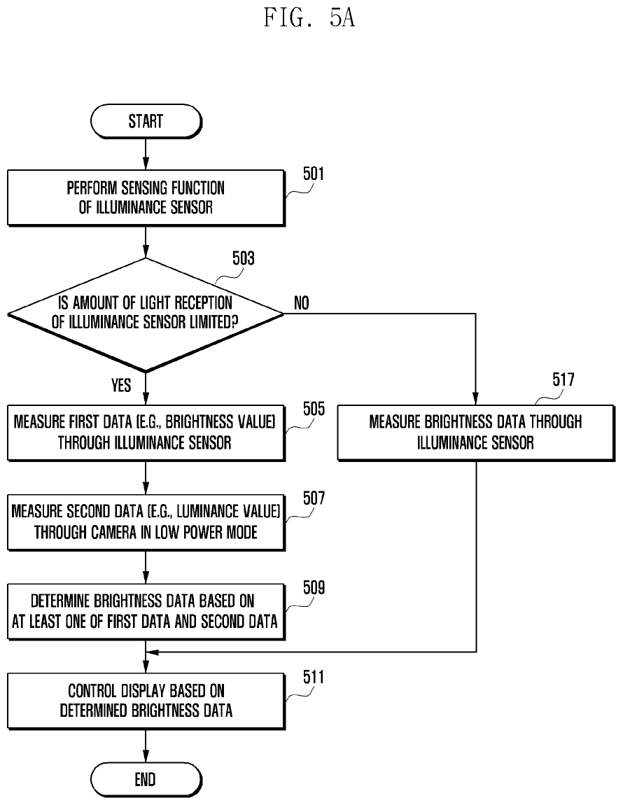

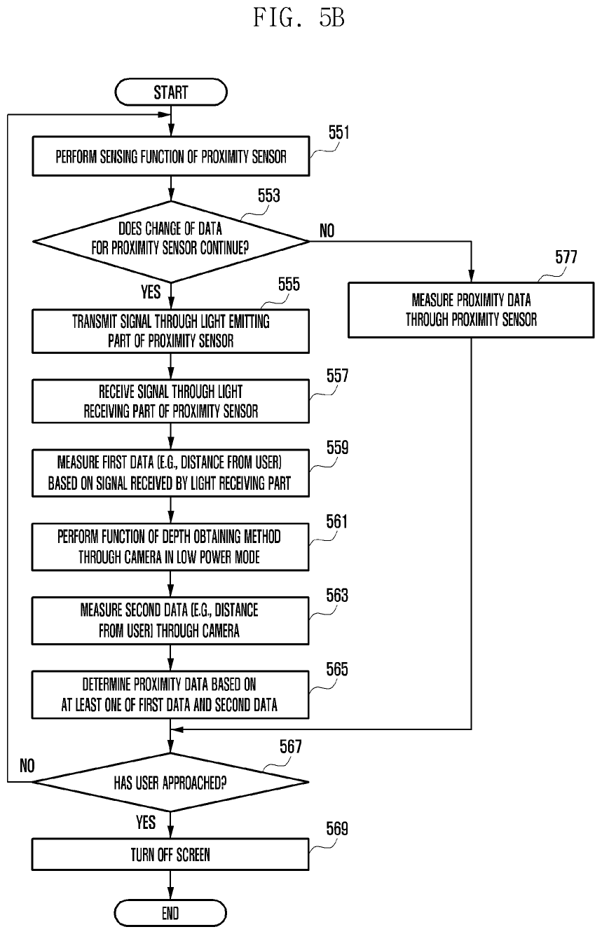

FIGS. 5A and 5B are flowcharts illustrating a method for supplementing sensing functions of an illuminance sensor and a proximity sensor utilizing a camera according to various embodiments.

FIG. 5A is a flowchart illustrating a method for sensing brightness of surroundings based on at least one of first data measured based on the illuminance sensor and second data measured based on the camera module. FIG. 5B is a flowchart illustrating a method for sensing whether the user has approached based on at least one of first data measured based on the proximity sensor and second data measured based on the camera module.

Referring to FIG. 5A, at operation 501, the processor (e.g., processor 310 of FIG. 3) of the electronic device (e.g., electronic device 301 of FIG. 3) may perform the sensing function using the illuminance sensor (e.g., illuminance sensor 321 of FIG. 3). For example, the processor 310 may detect the brightness (e.g., illumination, contrast, and saturation) of the surroundings through the illuminance sensor 321.

At operation 503, the processor 310 may determine whether the amount of light reception of the illuminance sensor 321 is limited. For example, the processor 310 may determine whether the amount of light reception is limited based on the operating range (e.g., reference value) corresponding to an ordinary amount of light reception. For example, the processor 310 may identify the amount of change of data for the illumination using the illuminance sensor 321, and if the amount of change of the data is smaller than the operating range, the processor 310 may determine that the amount of light reception is limited. According to an embodiment, if the amount of light reception of the illuminance sensor 321 is limited, the processor 310 may measure the brightness of the surroundings using another device (e.g., camera module (e.g., camera module 330 of FIG. 3)) in addition to the illuminance sensor 321. According to another embodiment, the processor 310 may identify the change of the data for the illumination using the illuminance sensor 321, and may determine whether the change of the data continues to exceed a reference time. According to another embodiment, if the change of the data continues to exceed the reference time, the processor 310 may measure the brightness of the surroundings using another device (e.g., camera module) in addition to the illuminance sensor 321. For example, the change of the data for the illumination may be a change at a level that deviates from the operating range.

If the amount of light reception of the illuminance sensor is limited at operation 503, the processor 310, at operation 505, may measure the first data (e.g., brightness value) through the illuminance sensor 321, and at operation 507, the processor 310 may measure the second data (e.g., luminance value) through the camera (e.g., camera module 330) in the low power mode. According to an embodiment, the camera may measure the data (e.g., luminance value) related to the brightness of the surroundings using the at least one function.

At operation 509, the processor 310 may determine brightness data based on at least one of the first data measured using the illuminance sensor 321 and the second data measured using the camera. According to an embodiment, if the first data is unstable, the processor 310 may determine the brightness data using the second data. According to another embodiment, if the first data is unstable, the processor 310 may determine the brightness data by integrating the first data and the second data. The processor 310 may determine the brightness data based on at least one of the first data and the second data. According to various embodiments, the illuminance sensor 321 may be disposed under the display (e.g., display 350 of FIG. 3), and the sensing function may be degraded by the display 350. According to an embodiment, in case that the electronic device 301 plays an image through the display 350, it may be difficult for the illuminance sensor 321 to measure an accurate illumination value. This may be a situation in which the first data measured through the illuminance sensor 321 is unstable, and the processor 310 may measure the first data using the illuminance sensor 321. According to an embodiment, the electronic device 301 may measure the first data using the illuminance sensor 321, and may measure the second data using the camera module 330. The electronic device 301 may determine the brightness data based on at least one of the first data and the second data.

At operation 511, the processor 310 may control the display 350 (e.g., display) based on the determined brightness data. For example, the processor 310 may identify whether the brightness data exceeds a configured threshold value by comparing the determined brightness data with the threshold value. The configured threshold value may be a preconfigured reference value corresponding to an external brightness, and the processor 310 may relatively adjust the brightness of the screen based on the threshold value.

According to an embodiment, the threshold value may be configured based on external environments (e.g., time (morning/afternoon/night), location of the electronic device (e.g., indoor and/or outdoor), and battery level). The threshold value may include a range value corresponding to a predetermined range. For example, if the external brightness data is measured as level 1 (e.g., brightness of about 1 to 10 lux) in a state where the threshold value is configured based on the external environment, the brightness of the display may be determined as a first brightness value based on the configured threshold value and the brightness data (level 1). For example, if the external brightness data is measured as level 2 (e.g., brightness of about 11 to 20 lux) in a state where the threshold value is configured based on the external environment, the brightness of the display may be determined as a second brightness value based on the configured threshold value and the brightness data (level 2).

According to an embodiment, the processor 310 may compare the determined brightness data with the configured threshold value, and may adjust the brightness of the display depending on the result of the comparison. For example, if the determined brightness date exceeds the configured threshold value, the processor 310 may adjust the display so that a brighter screen is displayed. If the determined brightness data does not exceed the configured threshold value, the processor 310 may control the display to display a darker screen. According to an embodiment, the threshold value may include a range value corresponding to a predetermined range. According to an embodiment, if the brightness data exceeds the operating range, the processor 310 may adjust the brightness of the display so that a brighter screen is displayed, whereas if the brightness data is lower than the operating range, the processor 310 may adjust the brightness of the display so that a darker screen is displayed. If the brightness data is included in the operating range, the processor 310 may maintain the current brightness of the display.

At operation 503, if the amount of light reception of the illuminance sensor 321 is not limited at operation 503, the processor 310, at operation 513, may measure the brightness data through the illuminance sensor 321. For example, under the condition that the brightness data can be measured using the illuminance sensor 321 only, the processor 310 may measure the brightness data based on the illuminance sensor 321 without utilizing supplemental data through another device (e.g., camera module 330).

According to an embodiment, if the illumination value measured using the illuminance sensor 321 is smaller than the configured threshold value when the current time is the daytime (e.g., morning to early evening), the processor 310 may utilize the luminance value by the camera module 330. The processor 310 may determine the brightness data based on at least one of the first data (e.g., illumination value measured using the illuminance sensor 321 and the second data (e.g., luminance value) measured using the camera module 330. The processor 310 may adjust the brightness of the display 350 (e.g., display) based on the determined brightness data.

According to an embodiment, the processor 310 may obtain GPS information through the communication module (e.g., communication module 190 of FIG. 1), and may identify whether the location of the electronic device 301 is outdoor or indoor based on the obtained GPS information. If the illumination value by the illuminance sensor 321 is smaller than the configured threshold value although the electronic device 301 is located outdoors, the processor 310 may utilize the luminance value by the camera module 330. For example, if the electronic device 301 is located outdoors in the afternoon, due to the strong sunlight, the processor 310 may measure the illuminance value using the illuminance sensor 321 only. For example, if the electronic device 301 is located indoors in the morning/evening time, the processor 310 may determine the brightness data based on the first data (e.g., illumination value) measured using the illuminance sensor 321 and the second data (e.g., luminance value) measured using the camera module 330. The brightness data can be integrated data of the first data and the second data. The processor 310 may adjust the brightness of the display 350 based on the determined brightness data.

According to an embodiment, the processor 310 may periodically measure the illumination value by the illuminance sensor 321 in accordance with the sensing period. If the sensitivity difference for the measured illumination value varies over the operating range for a predetermined time, the processor 310 may determine the brightness data based on at least one of the first data (e.g., illumination value) measured using the illuminance sensor 321 and the second data (e.g., luminance value) measured using the camera module 330. The processor 310 may adjust the brightness of the display 350 based on the determined brightness data.

Referring to FIG. 5B, at operation 551, the processor 310 of the electronic device 301 may perform the sensing function using the proximity sensor (e.g., proximity sensor 323 of FIG. 3). For example, the processor 310 may detect whether the user approaches through the proximity sensor 323.

At operation 553, the processor 310 may determine whether the change of the data for the proximity sensor 323 continues. For example, the situation in which the change of the data by the proximity sensor 323 continues may be the situation in which an image is played in the display (e.g., display 350 of FIG. 3). According to an embodiment, if the data by the proximity sensor 323 is changed from time to time, and thus it is difficult to measure an accurate proximity data, the processor 310 may measure the distance from the user by using another device (e.g., camera module 330) in addition to the proximity sensor 323. According to various embodiments, if the change of the data measured using the proximity sensor 323 continues, the proximity data may be measured using the camera module 330 that is another device. The camera module 330 may measure the distance from the user, and may measure the proximity data based on the measured distance. According to an embodiment, the change of the data for the proximity sensor 323 may be the change at the level that deviates from the operating range.

At operation 555, the processor 310 may transmit a signal (e.g., light emitting signal or first signal) through a light emitting part of the proximity sensor 323, and at operation 557, the processor 310 may receive a signal (e.g., light receiving signal or second signal) through a light receiving part of the proximity sensor 323. For example, the first signal transmitted through the light emitting part may be reflected corresponding to the subject (e.g., user), and the reflected signal may be the second signal. The proximity sensor 323 may include the light emitting part and the light receiving part, and may measure the distance from the user based on the first signal by the light emitting part and the second signal by the light receiving part. At operation 559, the processor 310 may measure the first data (e.g., distance from the user measured using the proximity sensor 323) based on the signal received by the light receiving part.

At operation 561, the processor 310 may perform a depth obtaining method (e.g., a focus adjustment method, a stereo vision method, a time of flight (TOF) method, a structured light method, and/or a method based on a gyro sensor) through the camera module 330 functioning in a low power mode. For example, the focus adjustment method may include an auto focus (AF) method and a manual focus (MF) method. The auto focus method may include an AF function, a contrast AF function, and a defocus from defocus (DFD) function. At operation 563, the processor 310 may measure the second data (e.g., distance from the user measured using the camera module 330) based on the depth obtaining method through the camera module 330. According to an embodiment, the processor 310 may measure the distance from the user utilizing at least one function of the depth obtaining method of the camera module 330 (e.g., focus adjustment method, stereo vision method, time of flight (TOF) method, structured light method, and/or method based on the gyro sensor). For example, the processor may identify whether the user is located near the electronic device, being closer than the detectable shortest distance using the depth obtaining method. The processor 310 may determine whether the user has approached using the depth obtaining method. According to an embodiment, the processor 310 may measure the distance from the user by using at least one function of the camera module 330, and may also determine whether the user has approached.

At operation 565, the processor 310 may determine the proximity data based on at least one of the first data and the second data. For example, the processor 310 may drive the camera module 330 in a low power mode based on the sensing period of the proximity sensor 323. The proximity sensor 323 may perform the sensing function at configured time interval (e.g., sensing period). According to an embodiment, if the light receiving signal corresponds to a threshold value for determining that the distance from the user has been changed from a long distance to a short distance based on the sensing period, the processor 310 may perform the low power mode for the camera module 330. For example, the proximity sensor 323 may determine whether the distance from the user is being reduced from the long distance to the short distance based on the first signal transmitted from the light emitting part and the second signal received by the light receiving part. The processor 310 may determine the proximity data based on at least one of the first data (e.g., distance from the user) by the proximity sensor 323 and the second data (e.g., distance from the user) by the camera in the low power mode.

According to various embodiments, the proximity sensor 323 may be disposed under the display 350, and thus the sensing function thereof may be degraded by the display 350. According to an embodiment, in case that the electronic device 301 plays an image through the display 350, it may be difficult for the proximity sensor 323 to measure accurate proximity data. For example, in case that the display 350 is turned on, and a bright image is played through the display 350, it may be difficult for the proximity sensor 323 to accurately measure the proximity data. Even in case that an image having a big change of brightness is played through the display 350, it may be difficult for the proximity sensor 323 to accurately measure the proximity data. According to various embodiments, in order to supplement the proximity data measured inaccurately, the processor 310 may utilize the depth obtaining method of the camera module 330.

According to an embodiment, the electronic device 301 may measure the first data using the proximity sensor 323, and may measure the second data using the camera module 330. The electronic device 301 may determine the proximity data based on at least one of the first data and the second data.

At operation 567, the processor 310 may determine whether the user has approached the electronic device 301 based on the determined proximity data. For example, the configured threshold value may be stored in the memory 340 of the electronic device 301, and the processor 310 may compare the determined proximity data with the configured threshold value. If the determined proximity data is less than the configured threshold value, the processor 310 may determine that the user has approached the electronic device 301.

If it is determined that the user has approached the electronic device 301 at operation 567, the processor 310, at operation 569, the processor 310 may turn off the display 350 (e.g., display or screen). If it is determined that the user has not approached the electronic device 301 at operation 567, the processor 310 may return to the start, and may perform the sensing function for detecting whether the user has approached.

According to an embodiment, if it is determined that the user has approached the electronic device 301, the processor 310 may identify whether the electronic device 301 is in a phone mode. For example, the phone mode may be a situation in which the user is talking with an opposite party on the phone (e.g., execution of a phone call application) through the electronic device 301. According to an embodiment, when the user is on the phone, the display 350 of the electronic device 301 may be located adjacent to the face of the user, in particular, the ear, cheek, or mouth. According to an embodiment, if the electronic device 301 is in the phone mode, the electronic device 301 may deactivate the display 350 (e.g., turn off the screen) in order to reduce the possibility of malfunction due to the user's body contact.

According to an embodiment, if it is determined that the user has approached the electronic device 301, the processor 310 may determine whether the electronic device 301 is in an always on display (AOD) mode. For example, the AOD mode may be a mode in which the electronic device 301 activates at least a partial area of the display 350, and may be a mode in which only partial information configured to reduce power consumption is displayed through the display 350. If the electronic device 301 is in the AOD mode, the processor 310 may maintain the AOD mode as it is. For example, the processor 310 may activate at least a partial area of the display panel corresponding to the display 350, and may perform the AOD function based on the at least a partial area being activated. If the electronic device 301 is not in the AOD mode, the processor 310 may deactivate the display 350 (e.g., turn off the screen) in order to prevent the malfunction caused by the body contact.

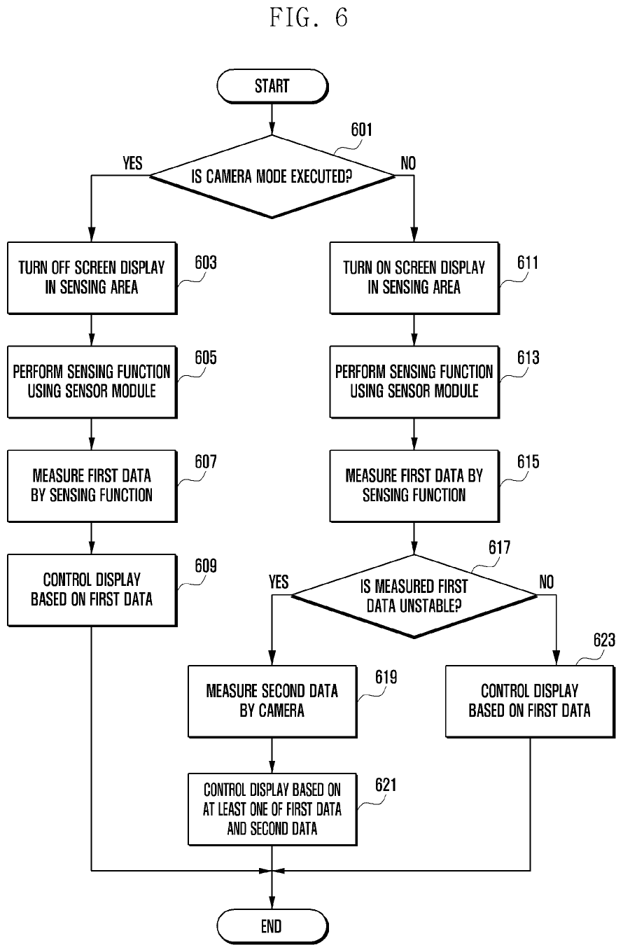

FIG. 6 is a flowchart illustrating a method for performing a sensing function depending on whether to execute a camera mode according to various embodiments.

Referring to FIG. 6, at operation 601, the processor (e.g., processor 310 of FIG. 3) of the electronic device (e.g., electronic device 301 of FIG. 3) may identify whether to execute a camera mode. For example, the camera mode may be a mode in which at least one subject (e.g., object) is photographed using the camera module (e.g., camera module 330 of FIG. 3). The processor 310 may identify the execution of an application for activating the camera module 330, and may activate the camera module 330 in response to the execution of the application. In case that the camera-related application is executed, the processor 310 may photograph the subject using the camera module 330. According to an embodiment, a case that the camera mode is under execution may mean a case that the camera-related application is under execution. According to an embodiment, a case that the camera mode is not under execution may mean a case that at least a partial function of the camera is activated in the low power mode.

If the camera mode is under execution at operation 601, the processor 310, at operation 603, may stop the screen display on the sensing area (e.g., sensing area 240 of FIG. 2). For example, the sensing area 240 may be determined corresponding to an area in which the sensor module (e.g., sensor module 220 of FIG. 2 or sensor module 320 of FIG. 3) is disposed. The sensor module 320 may be disposed under the display 350 of the electronic device 301. The processor 310 may control the display 350 so that the screen is not displayed corresponding to the sensing area 240.

At operation 605, the processor 310 may perform the sensing operation using the sensor module 320. For example, since the screen is not displayed corresponding to the sensing area 240, the sensor module 320 may perform the sensing function more stably.

At operation 607, the processor 310 may measure the first data by the sensing function. At operation 609, the processor 310 may control the display (e.g., display 350 of FIG. 3 or display) based on the measured first data.

If the camera mode is not executed at operation 601, the processor 310, at operation 611, may maintain the screen display on the sensing area 240. For example, a state where the camera mode is not executed may be a state where at least one function of the camera module (e.g., camera module 330 of FIG. 3) can be utilized.

At operation 613, the processor 310 may perform the sensing function using the sensor module 320. Since the screen is being displayed even on the sensing area 240, the sensor module 320 may perform the sensing function somewhat unstably.

At operation 615, the processor 310 may measure the first data by the sensing function. At operation 617, the processor 310 may determine whether the measured first data is unstable. For example, the processor 310 may repeatedly measure the first data in accordance with the configured time intervals, and may determine that the first data is unstable in case that the measured first data deviates from the operating range, and is changed from time to time. For example, if the measured first data is included in the operating range, the processor 310 may determine that the first data is stable.

If the first data is unstable at operation 617, the processor 310, at operation 619, may measure the second data by the camera module 330. For example, the processor 310 may measure the second data using at least a partial function of the camera module 330 (e.g., depth obtaining method).

At operation 621, the processor 310 may control the display 350 based on the at least one of the first data and the second data.

If the first data is stable at operation 617, the processor 310, at operation 623, may control the display 350 based on the measured first data.

According to various embodiments, the processor 310 of the electronic device 301 may determine the screen display for the sensing area 240 depending on whether the camera mode is executed. For example, if the camera mode is under execution, the processor 310 may stop the screen display for the sensing area 240, and measure the first data based on the sensor module 320 disposed in the sensing area 240. The processor 310 may perform the sensing function based on the measured first data.

For example, if the camera mode is not under execution, the processor 310 may maintain the screen display for the sensing area 240, and measure the first data based on the sensor module 320 disposed in the sensing area 240. If it is determined that the measured first data is unstable, the processor 310 may measure the second data using the at least one function of the camera module 330. The processor 310 may perform the sensing function based on at least one of the measured first data and the measured second data.

A method according to various embodiments of the disclosure may include: performing a sensing function using a sensor module (e.g., sensor module 320 of FIG. 3); measuring first data by a sensing function of the sensor module 320; identifying an amount of the first data that deviates from an operating range; and performing at least one function of a camera module (e.g., the camera module 330 of FIG. 3) using the camera module 330 in response to the amount of change of the first data deviating from the operating range.

The method according to various embodiments may measure second data by the at least one function of the camera module 330, and may at least partly control the display based on at least one of the first data and the second data.

The method according to various embodiments may measure the first data corresponding to an illumination value using an illuminance sensor 321 included in the sensor module 320, identify that the illumination value of the illuminance sensor is under a threshold, and perform the at least one function of the camera module 330 in response to identifying that the illumination value is under the threshold.

The method according to various embodiments may measure second data corresponding to a luminance value of surroundings using the camera module 330.

The method according to various embodiments may identify whether the change of the data measured continues using the proximity sensor 323 included in the sensor module 320, and may perform at least one function of the camera module 330 depending on the result of the identifying.

The method according to various embodiments may measure the first data corresponding to a distance from a user based on a transmitted light emitting signal and a received light receiving signal using a proximity sensor 323, and measure the second data corresponding to the distance from the user based on a depth obtaining method using the camera module 330.

The method according to various embodiments may identify whether the electronic device is in an always on display (AOD) mode, in response to identifying that the electronic device is in the AOD mode, maintain a state of the display, and, in response to identifying that the electronic device is not in the AOD mode, at least partly turn off the display.

Embodiments of the disclosure that are disclosed in the specification and drawings are merely for easy explanation of the technical contents of the embodiments of the disclosure and proposal of specific examples to help understanding of embodiments of the disclosure, but are not intended to limit the scope of the disclosure. Accordingly, it should be construed that all changes or modifications derived based on the technical concept of the various embodiments of the disclosure are included in the scope of the various embodiments of the disclosure in addition to the embodiments disclosed herein.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a display;
a camera module;
a sensor module disposed under the display and configured to perform a sensing function;
a processor operatively connected to the display, the camera module, and the sensor module; and
a memory operatively connected to the processor,
wherein the memory, when executed, stores instructions for causing the processor to:
measure first data using the sensor module,
identify an amount of the first data that deviates from an operating range, and
perform at least one function of the camera module in response to the amount of the first data deviating from the operating range.

2. The electronic device of claim 1, wherein the instructions cause the processor to:
measure second data by the at least one function of the camera module, and
at least partly control the display based on at least one of the first data and the second data.

3. The electronic device of claim 1, wherein:
the sensor module comprises at least one of an illuminance sensor and a proximity sensor, and
the at least one of the illuminance sensor and the proximity sensor is disposed under a display panel of the display.

4. The electronic device of claim 1, wherein:
the sensor module comprises an illuminance sensor disposed under a display panel of the display, and
the instructions cause the processor to:
measure the first data corresponding to an illumination value using the illuminance sensor,
identify that the illumination value of the illuminance sensor is under a threshold, and
perform the at least one function of the camera module in response to identifying that the illumination value is under the threshold.

5. The electronic device of claim 4, wherein the instructions cause the processor to:
measure second data corresponding to a luminance value of surroundings using the camera module,
identify integrated data based on the first data and the second data, and
adjust a brightness of the display based on the identified integrated data.

6. The electronic device of claim 1, wherein:
the sensor module comprises a proximity sensor disposed under a display panel of the display, and
the instructions cause the processor to:
measure the first data corresponding to a distance from a user using the proximity sensor, and
measure second data corresponding to the distance from the user based on a depth obtaining method using the camera module.

7. The electronic device of claim 6, wherein:
the depth obtaining method comprises at least one method of a focus adjustment method, a stereo vision method, a time of flight (TOF) method, a structured light method, and a gyro method based on a gyro sensor, and
the instructions cause the processor to measure the second data using the camera module based on the at least one method.

8. The electronic device of claim 6, wherein the instructions cause the processor to:
identify integrated data based on the first data and the second data, and
control the display based on the identified integrated data.

9. The electronic device of claim 1, wherein the instructions cause the processor to:
identify whether the electronic device is in an always on display (AOD) mode,
in response to identifying that the electronic device is in the AOD mode, maintain a state of the display, and
in response to identifying that the electronic device in not in the AOD mode, at least partly turn off the display.

10. The electronic device of claim 1, wherein:
the display has a partial area corresponding to a sensing area of the sensor module, and
the instructions cause the processor to:
identify whether a camera mode is executed through the camera module,
in response to identifying that the camera mode is executed,
turn off at least the partial area of the display ,
measure the first data by the sensing function of the sensor module, and
control the display based on the measured first data, and
in response to identifying that the camera mode is not executed,
measure the first data by the sensing function of the sensor module in case that the camera mode is not executed,
measure second data by the at least one function of the camera module, and
control the display based on at least one of the measured first data and the measured second data.

11. A method comprising:
performing a sensing function using a sensor module disposed under a display of an electronic device;
measuring first data using the sensor module;
identifying an amount of the first data that deviates from an operating range; and
performing at least one function of a camera module in response to the amount of the first data deviating from the operating range.

12. The method of claim 11, further comprising:
measuring second data by the at least one function of the camera module; and
at least partly controlling the display based on at least one of the first data and the second data.

13. The method of claim 11, comprising:
measuring the first data corresponding to an illumination value using an illuminance sensor included in the sensor module;
identifying that the illumination value of the illuminance sensor is under a threshold;
performing the at least one function of the camera module in response to identifying that the illumination value is under the threshold;
measuring second data corresponding to a luminance value of surroundings using the camera module;
identifying integrated data based on the first data and the second data; and
adjusting a brightness of the display based on the identified integrated data.

14. The method of claim 11, further comprising:
measuring the first data corresponding to a distance from a user using a proximity sensor disposed under a display panel of the display of the electronic device; and
measuring second data corresponding to the distance from the user based on a depth obtaining method using the camera module.

15. The method of claim 11, further comprising:
identifying whether the electronic device is in an always on display (AOD) mode;
in response to identifying that the electronic device is in the AOD mode, maintaining a state of the display; and
in response to identifying that the electronic device is not in the AOD mode, at least partly turning off the display.

16. The method of claim 14, wherein
the depth obtaining method comprises at least one method of a focus adjustment method, a stereo vision method, a time of flight (TOF) method, a structured light method, and a gyro method based on a gyro sensor, and
the method further comprises measuring the second data using the camera module based on the at least one method.

17. The method of claim 14, further comprising:
identifying integrated data based on the first data and the second data, and controlling the display based on the identified integrated data.

18. The method of claim 11, wherein:
the display has a partial area corresponding to a sensing area of the sensor module, and
the method further comprises:
identifying whether a camera mode is executed through the camera module,
in response to identifying that the camera mode is executed,
turning off at least the partial area of the display in response to identifying that the camera mode is executed,
measuring the first data by the sensing function of the sensor module, and
controlling the display based on the measured first data, and
in response to identifying that the camera mode is not executed,
measuring the first data by the sensing function of the sensor module in case that the camera mode is not executed,
measuring second data by the at least one function of the camera module, and
controlling the display based on at least one of the measured first data and the measured second data.

19. A non-transitory computer readable medium containing instructions that when executed further cause a processor to:
perform a sensing function using a sensor module disposed under a display of an electronic device
measure first data using the sensor module,
identify an amount of the first data that deviates from an operating range, and
perform at least one function of a camera module in response to the amount of the first data deviating from the operating range.

20. The computer readable medium of claim 19, wherein the instructions that when executed further cause the processor to:
measure second data by the at least one function of the camera module, and
at least partly control the display based on at least one of the first data and the second data.
